(19) United States
(12) Patent Application Publication
(10) Pub. No.: US 2019/0275882 A1
(43) Pub. Date: Sep. 12, 2019

(54) HIGH PRESSURE TANK APPARATUS

(71) Applicant: HONDA MOTOR CO., LTD., Tokyo (JP)

(72) Inventors: Naoki OGIWARA, WAKO-SHI (JP); Toshihiko KANEZAKI, WAKO-SHI (JP); Takatsugu KOYAMA, WAKO-SHI (JP)

(21) Appl. No.: 16/294,149

(22) Filed: Mar. 6, 2019

(30) Foreign Application Priority Data
Mar. 7, 2018 (JP) 2018-040385

(51) Int. Cl. B60K 15/03; F17C 13/02; F17C 1/04; F17C 7/02

(52) U.S. Cl. CPC B60K 15/03177; F17C 13/025; F17C 1/04; B60K 2015/03046; B60K 2015/03296; B60K 2015/03315; F17C 7/02

(57) ABSTRACT

A high pressure tank of a high pressure tank apparatus includes: a resin-made liner storing a fuel gas to be supplied to a fuel cell; a reinforced layer covering an outer surface of the liner; an inserting member having formed therein a supplying/discharging hole; and a supplying/discharging-side cap having formed therein a supplying/discharging-side lead-out hole. There is a leaked fluid storage section capable of storing a leaked fluid that has leaked from at least a connecting section connecting the supplying/discharging hole and a supplying/discharging flow path. There is a supplying/discharging-side discharge flow path provided independently from the leaked fluid storage section and by which a temporary release fluid that has been led out via the supplying/discharging-side lead-out hole is led to a diluting unit that dilutes an anode off-gas that has been discharged from the fuel cell.

### CROSS-REFERENCE TO RELATED APPLICATION

This application is based upon and claims the benefit of priority from Japanese Patent Application No. 2018-040385 filed on Mar. 7, 2018, the contents of which are incorporated herein by reference.

### BACKGROUND OF THE INVENTION

### Field of the Invention

The present invention relates to a high pressure tank apparatus that includes a high pressure tank in which a fluid is supplied/discharged to/from a resin-made liner via a supplying/discharging flow path and which enables the fluid that has been stored in the liner to be supplied to an anode electrode of a fuel cell.

### Description of the Related Art

There is known a high pressure tank that includes: a resin-made liner capable of storing a fluid on its inside; a reinforced layer configured from the likes of a fiber-reinforced plastic, that covers an outer surface of the liner; a cap that is provided in an opening of the liner and the reinforced layer, and has formed therein an insertion hole that communicates the inside and an outside of the liner; and an inserting member that is inserted in the insertion hole. The inserting member has formed therein a supplying/discharging hole penetrating the inserting member, and a supplying/discharging flow path for supplying/discharging the fluid to/from the inside of the liner is connected to the supplying/discharging hole via a connecting section. Moreover, the inserting member has incorporated therein a main stop valve by which communication or blocking communication between the inside of the liner and the supplying/discharging flow path via the supplying/discharging hole can be switched.

In a high pressure tank apparatus including this kind of high pressure tank, there is generally included a configuration enabling detection of fluid leaking from the high pressure tank, and so on, during an abnormality of the high pressure tank apparatus. Moreover, when leakage during an abnormality has been detected, a countermeasure such as closing the above-described main stop valve to stop supplying/discharging of the fluid is taken. As an example of a configuration enabling detection of leakage during an abnormality, there may be cited: a storage section surrounding the likes of the high pressure tank or supplying/discharging flow path to enable storage of a leaked fluid that has leaked; and a sensor that detects the fluid within the storage section.

Incidentally, as described in Japanese Laid-Open Patent Publication No. 2009-243675, for example, in a high pressure tank including a resin-made liner, the fluid sometimes permeates the liner to enter between the outer surface of the liner and the reinforced layer (hereafter, also called a covered section), and so on. There is concern that if the fluid accumulates in the covered section, there will more easily occur the likes of separation of the liner and the reinforced layer, or buckling where the liner projects toward its inside. Therefore, the fluid that has permeated the liner to enter the covered section is preferably led out to outside of the covered section.

The fluid led out from the covered section (hereafter, also called a temporary release fluid) occurs in a temporarily limited amount, hence is discharged to outside of the high pressure tank as part of normal operation of the high pressure tank apparatus. In other words, the temporary release fluid differs from the leaked fluid that leaks during an abnormality of the high pressure tank apparatus.

### SUMMARY OF THE INVENTION

In the high pressure tank apparatus provided with the storage section or sensor as described above, the temporary release fluid and the leaked fluid are similarly stored in the storage section, hence there is concern that when the temporary release fluid that has been led out during normal operation has been detected by the sensor, it will end up being mistakenly detected that the leaked fluid leaking during an abnormality has occurred.

A main object of the present invention is to provide a high pressure tank apparatus which can avoid it being mistakenly detected during normal operation that a leakage during an abnormality has occurred, and moreover, which is capable of being easily mounted in a mounting body at low cost.

According to an embodiment of the present invention, there is provided a high pressure tank apparatus that includes a high pressure tank in which a fluid is supplied/discharged to/from a resin-made liner via a supplying/discharging flow path and which enables the fluid that has been stored in the liner to be supplied to an anode electrode of a fuel cell, the high pressure tank including: a reinforced layer covering an outer surface of the liner; an inserting member having formed therein a supplying/discharging hole that is connected to the supplying/discharging flow path via a connecting section and that is capable of communicating the supplying/discharging flow path and an inside of the liner; and a cap having formed therein each of a lead-out hole that leads out the fluid interposing between the liner and the reinforced layer and an insertion hole in which the inserting member is inserted, the high pressure tank apparatus including: a leaked fluid storage section capable of storing a leaked fluid being the fluid that has leaked from at least the connecting section; and a discharge flow path that is provided independently from the leaked fluid storage section and by which a temporary release fluid being the fluid that has been led out via the lead-out hole is led to a diluting unit that dilutes an anode off-gas that has been discharged from the anode electrode.

The connecting section of the supplying/discharging flow path and the supplying/discharging hole is a place set so as to prevent leakage of the fluid occurring during normal operation of the high pressure tank apparatus. Therefore, the leaked fluid being the fluid that has leaked from at least the connecting section is a fluid that has leaked due to an abnormality occurring in the high pressure tank apparatus. On the other hand, the temporary release fluid is a fluid that, during normal operation of the high pressure tank apparatus, has permeated the liner to enter between the outer surface of the liner and the reinforced layer (hereafter, also called a covered section), and has then been led out to outside of the covered section via the lead-out hole.

In this high pressure tank apparatus, the leaked fluid storage section that stores the leaked fluid and the discharge flow path by which the temporary release fluid is led to the diluting unit, are provided independently. Thus, since the leaked fluid not including the temporary release fluid can be stored in the leaked fluid storage section, the leaked fluid that leaks during an abnormality can be detected distinctly from the temporary release fluid led out during normal operation. As a result, it can be avoided that during normal operation of the high pressure tank apparatus, it is mistakenly detected that leakage during an abnormality has occurred.

In the fuel cell of which the anode electrode is supplied with the fluid stored in the liner, the anode off-gas that includes an unconsumed portion of the fluid that has not been consumed by the fuel cell, is discharged from the anode electrode. Therefore, in order that a concentration of the fluid in the anode off-gas attains a magnitude enabling release to the atmosphere, the fuel cell is additionally provided with the diluting unit that utilizes the likes of a cathode off-gas discharged from a cathode electrode of the fuel cell, or the atmosphere to dilute the anode off-gas, for example.

In this high pressure tank apparatus, the temporary release fluid can be led to the diluting unit by the discharge flow path. Therefore, the diluting unit additionally provided to the fuel cell can be utilized to dilute the temporary release fluid. Hence, the high pressure tank apparatus can be easily mounted at low cost in a mounting body of the high pressure tank apparatus, without there being newly provided the likes of a configuration for diluting the temporary release fluid, or a configuration for increasing a sealing property to suppress entry of the undiluted temporary release fluid.

In the above-described high pressure tank apparatus, it is preferable that there be further included an opening/closing valve that opens/closes the discharge flow path, and that the opening/closing valve is opened during dilution operation by the diluting unit. In this case, the temporary release fluid can be led by the discharge flow path to the diluting unit during dilution operation by the diluting unit, so it becomes possible for the temporary release fluid to be more certainly diluted.

In the above-described high pressure tank apparatus, it is preferable that the opening/closing valve is opened during electricity generation operation of the fuel cell. During electricity generation operation of the fuel cell, the diluting unit is in dilution operation to dilute the anode off-gas using the cathode off-gas discharged from the fuel cell.

Moreover, during electricity generation operation of the fuel cell, the fluid is discharged from the liner in order to be supplied to the fuel cell. When an internal pressure of the liner lowers due to this discharging of the fluid, a pressing force with which the liner is pressed toward the reinforced layer becomes smaller, so it becomes easier for the fluid that has permeated the liner to enter the covered section between the liner and the reinforced layer. As a result, it becomes easier for the temporary release fluid to be led out from the lead-out hole.

Hence, by the opening/closing valve being opened during electricity generation operation of the fuel cell, the temporary release fluid can be effectively led to the diluting unit and can be certainly diluted by the diluting unit, at a timing when it is easy for the temporary release fluid to flow into the discharge flow path from the lead-out hole.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic configuration diagram of a high pressure tank apparatus, a supplying/discharging flow path, and a fuel cell system according to an embodiment of the present invention;

FIG. 2 is an enlarged cross-sectional view of essential parts on a side of one end in an axial direction of the high pressure tank apparatus of FIG. 1;

FIG. 3 is an enlarged cross-sectional view of essential parts on a side of the other end in the axial direction of the high pressure tank apparatus of FIG. 1; and

FIG. 4 is an enlarged cross-sectional view of essential parts on a side of one end in an axial direction of a high pressure tank apparatus according to a modified example.

### DESCRIPTION OF THE PREFERRED EMBODIMENTS

A preferred embodiment of a high pressure tank apparatus according to the present invention will be presented and described in detail with reference to the accompanying drawings. Note that in the drawings below, configuring elements displaying the same or similar functions and advantages will be assigned with the same reference symbols, and repeated descriptions thereof will sometimes be omitted.

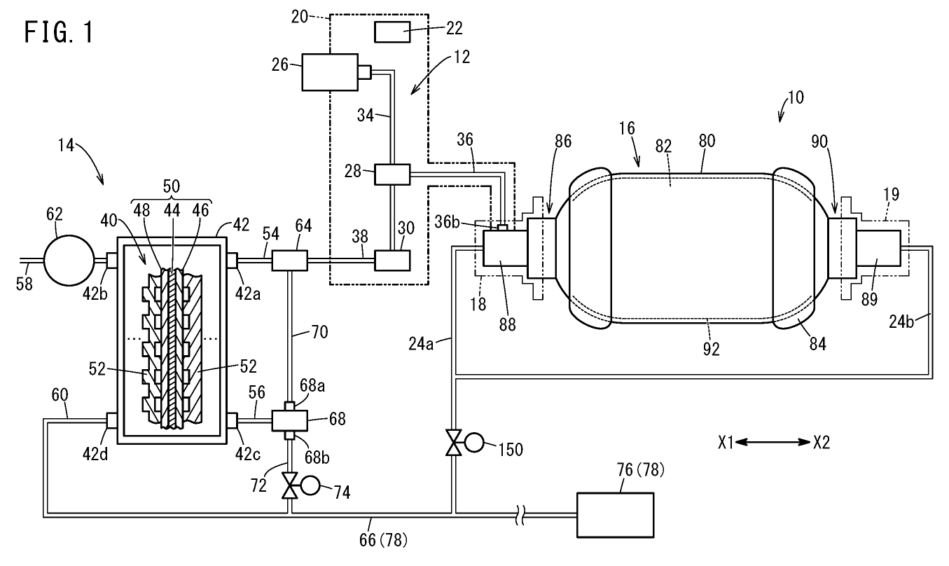

As shown in FIG. 1, a high pressure tank apparatus 10 according to the present embodiment can be preferably employed as a high pressure tank apparatus that is mounted in a mounting body (not illustrated) being a fuel cell vehicle such as a fuel cell electric automobile, for example, and that includes a high pressure tank 16 storing a fuel gas (a fluid) supplied to a fuel cell system 14 via a supplying/discharging flow path 12. Accordingly, although the present embodiment describes an example where the mounting body is assumed to be a fuel cell vehicle, the present embodiment is not particularly limited to this. The high pressure tank apparatus 10 may be mounted in a mounting body other than a fuel cell vehicle.

The high pressure tank apparatus 10 mainly includes: the high pressure tank 16 that is supplied with/discharges the fuel gas via the supplying/discharging flow path 12; cover members 18, 19; a leaked fluid storage section 20; a leakage detecting sensor 22; a supplying/discharging-side discharge flow path 24a (a discharge flow path); and an end-side discharge flow path 24b.

The supplying/discharging flow path 12 is for example configured capable of supplying to the high pressure tank 16 via a branch path 28 the fuel gas that has been supplied from a filling port 26, and capable of supplying to a regulator 30 via the branch path 28 the fuel gas that has been discharged from the high pressure tank 16 and after pressure-adjusting the fuel gas by the regulator 30, supplying the fuel gas to the fuel cell system 14. In this case, the supplying/discharging flow path 12 is configured by the likes of: a pipe 34 connecting between the filling port 26 and the branch path 28; a pipe 36 connecting the branch path 28 and the high pressure tank 16; and a pipe 38 connecting the branch path 28 and the fuel cell system 14 via the regulator 30.

The fuel cell system 14 includes a fuel cell 42 configured from a stack (not illustrated) having stacked therein a plurality of electricity generating cells 40. The individual electricity generating cells 40 are configured by, for example, sandwiching by a pair of separators 52 an electrolyte-film/electrode structure 50 that includes: an electrolyte film 44 configured from a solid polymer; and an anode electrode 46 and cathode electrode 48 that face each other sandwiching the electrolyte film 44.

A fuel gas supply port 42a provided in the fuel cell 42 is supplied with a hydrogen gas as the fuel gas from the high pressure tank 16, whereby each of the anode electrodes 46 of the fuel cell 42 is configured capable of being supplied with the fuel gas. Moreover, an oxygen-containing gas supply port 42b provided in the fuel cell 42 is supplied with the likes of the atmosphere including oxygen as an oxygen-containing gas, whereby each of the cathode electrodes 48 of the fuel cell 42 is configured capable of being supplied with the oxygen-containing gas. In the fuel cell 42, the fuel gas and the oxygen-containing gas that have been supplied as described above are consumed in an electrochemical reaction (an electricity generating reaction) at the anode electrode 46 and the cathode electrode 48, whereby electricity generation is performed.

Moreover, an anode off-gas that has been discharged from each of the anode electrodes 46 without being consumed in the above-described electricity generating reaction, of the fuel gas that has been supplied from the fuel gas supply port 42a is configured capable of being discharged to outside of the fuel cell 42 from an anode off-gas discharge port 42c provided in the fuel cell 42. Similarly, a cathode off-gas that has been discharged from each of the cathode electrodes 48 without being consumed in the above-described electricity generating reaction, of the oxygen-containing gas that has been supplied from the oxygen-containing gas supply port 42b is configured capable of being discharged to outside of the fuel cell 42 from a cathode off-gas discharge port 42d provided in the fuel cell 42.

A fuel gas supplying flow path 54 is connected to the fuel gas supply port 42a, and an anode off-gas discharging flow path 56 is connected to the anode off-gas discharge port 42c. An oxygen-containing gas supplying flow path 58 is connected to the oxygen-containing gas supply port 42b, and a cathode off-gas discharging flow path 60 is connected to the cathode off-gas discharge port 42d.

The oxygen-containing gas supplying flow path 58 is provided with an air pump 62. The air pump 62 is driven, whereby compressed air is taken in as the oxygen-containing gas into the oxygen-containing gas supplying flow path 58 from the atmosphere. The fuel gas that has been discharged from the pipe 38 of the supplying/discharging flow path 12 is supplied, via an injector (not illustrated) and an ejector 64, to the fuel gas supplying flow path 54. A downstream side of the cathode off-gas discharging flow path 60 is connected to a mixed exhaust gas discharging flow path 66.

A gas-liquid separator 68 is connected to a downstream side of the anode off-gas discharging flow path 56. As a result, the anode off-gas that has been discharged to the anode off-gas discharging flow path 56 from the anode off-gas discharge port 42c flows into the gas-liquid separator 68 to be separated into a circulating gas being a gas component and a discharge fluid including a liquid.

A gas discharge port 68a discharging the circulating gas of the gas-liquid separator 68 is connected to a circulation flow path 70. A downstream side of the circulation flow path 70 is connected to the fuel gas supplying flow path 54 via the ejector 64. As described above, the fuel gas from the pipe 38 is injected into the ejector 64 via the injector provided on the upstream side of the ejector 64. As a result, the ejector 64 mixes the fuel gas injected into it as described above and the circulating gas, and discharges them to the fuel gas supplying flow path 54 provided on its downstream side.

A liquid discharge port 68b discharging the discharge fluid of the gas-liquid separator 68 is connected to a connection flow path 72. The connection flow path 72 has a drain valve 74 installed therein in an intervening manner, and a downstream side of the drain valve 74 is connected to the mixed exhaust gas discharging flow path 66. A diluter 76 is connected to a downstream side of this mixed exhaust gas discharging flow path 66. These mixed exhaust gas discharging flow path 66 and diluter 76 configure a diluting unit 78.

In the diluting unit 78, the discharge fluid (the anode off-gas) that has flowed into the mixed exhaust gas discharging flow path 66 via the drain valve 74 from the connection flow path 72 is diluted by being mixed with the cathode off-gas in the mixed exhaust gas discharging flow path 66. Moreover, the discharge fluid that has been mixed with the cathode off-gas is further diluted by being mixed with the atmosphere in the diluter 76. As a result, the discharge fluid, after having been diluted so that, for example, a concentration of the hydrogen gas in the discharge fluid attains a magnitude enabling release to the atmosphere, is discharged into the atmosphere on an outside of the mounting body.

The diluter 76 is not particularly limited, provided it has a configuration enabling the atmosphere to be mixed into the fluid discharged from the mixed exhaust gas discharging flow path 66. There may be cited as one example of the configuration of the diluter 76 a configuration where a negative pressure due to a main flow ejected from the mixed exhaust gas discharging flow path 66 is employed to suck the atmosphere being a sub flow, and the main flow and the sub flow are mixed. Moreover, the diluter 76 may adopt a configuration where a running wind occurring when the mounting body runs is taken in, and the running wind is mixed as the atmosphere into the fluid discharged from the mixed exhaust gas discharging flow path 66.

As shown in FIGS. 1 to 3, the high pressure tank 16 includes a reinforced layer 80, a liner 82, a protective member 84, a supplying/discharging-side cap 86 (a cap), inserting members 88, 89, and an end-side cap 90. The high pressure tank 16 has the supplying/discharging-side cap 86 provided on one end side (a side of arrow X1 in FIG. 1) in its axial direction (hereafter, the axial direction of the high pressure tank 16 will also simply be called an axial direction), and has the end-side cap 90 provided on its other end side (a side of arrow X2 in FIG. 1) in the axial direction.

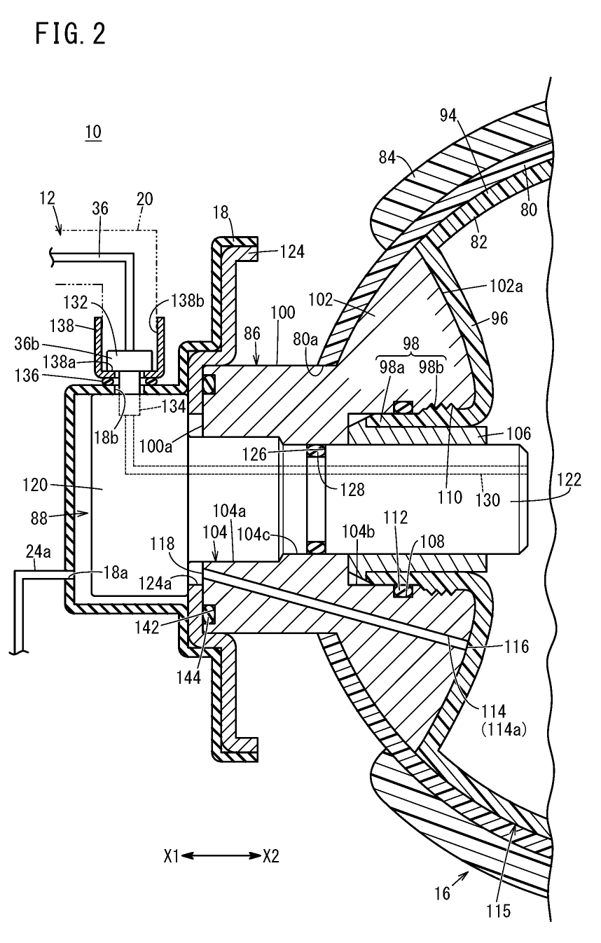

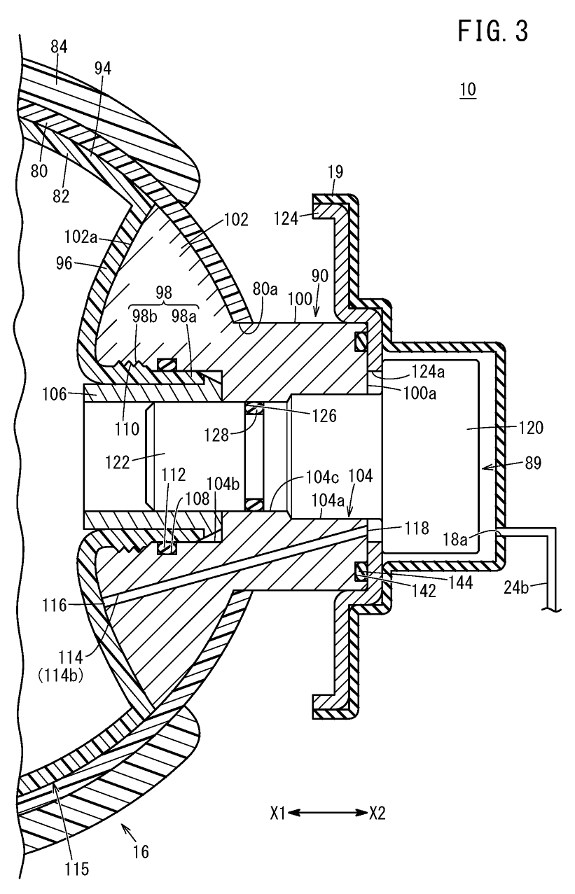

The reinforced layer 80 is configured from the likes of a carbon fiber reinforced plastic (CFRP), and covers an outer surface of the liner 82, and so on. The liner 82 is a hollow body configured from a resin, and is capable of storing the fuel gas on its inside. Specifically, the liner 82 includes: a cylindrical trunk section 92 (refer to FIG. 1); a dome-like section 94 (refer to FIGS. 2 and 3) provided on both sides in the axial direction of the trunk section 92; a sunken section 96 (refer to FIGS. 2 and 3) provided on both sides in the axial direction of the dome-like section 94; and a cylindrical section 98 (refer to FIGS. 2 and 3) that projects from the sunken section 96 and has a smaller diameter than the trunk section 92. Note that in the present embodiment, the reinforced layer 80 and the liner 82 have their one end side and their other end side in the axial direction configured substantially similarly.

The sunken section 96 sinks toward the inside where the fuel gas of the liner 82 is stored. The cylindrical section 98 has a thin section 98a provided on its projecting end side (a side of arrow X1 in FIG. 2), and has a male thread 98b provided more to its base end side (a side of arrow X2 in FIG. 2) than the thin section 98a.

The protective member 84 is configured from the likes of a resin, for example, and covers, via the reinforced layer 80, mainly a boundary portion of the dome-like section 94 and trunk section 92 of the liner 82 and a periphery of the boundary portion. By the protective member 84 being thus provided, impact resistance, and so on, of the high pressure tank 16 can be improved.

As shown in FIG. 2, the supplying/discharging-side cap 86 is made of a metal, for example, and is sheathed by the cylindrical section 98 of the liner 82. Moreover, the supplying/discharging-side cap 86 includes a cylindrical projection 100 and a shoulder section 102 that extends outwardly in a radial direction from a base end of the projection 100, and there is an insertion hole 104 formed penetrating along an axial direction of the projection 100. An end surface 102a on an opposite side to the projection 100 (the side of arrow X2 in FIG. 2), of the shoulder section 102 faces an outer surface of the sunken section 96 of the liner 82. Moreover, an outer peripheral surface of the shoulder section 102, along with the trunk section 92 and dome-like section 94 of the liner 82, are covered by the reinforced layer 80. The projection 100 projects so as to be exposed from an opening 80a provided in the reinforced layer 80.

The insertion hole 104 has diameters that differ depending on regions and includes: a medium inner diameter hole 104a positioned on a tip surface 100a side of the projection 100; a large inner diameter hole 104b positioned on an end surface 102a side of the shoulder section 102; and a small inner diameter hole 104c positioned between these medium inner diameter hole 104a and large inner diameter hole 104b. The cylindrical section 98 of the liner 82 is inserted in the large inner diameter hole 104b, and a cylindrical collar 106 is press-fitted into the cylindrical section 98. As a result, the cylindrical section 98 is supported between an inner circumferential surface of the large inner diameter hole 104b and an outer circumferential surface of the collar 106.

An annular seal groove 108 that follows a circumferential direction is formed in an inner wall of the large inner diameter hole 104b in a region facing the thin section 98a of the cylindrical section 98, and a female thread 110 that is screwed onto the male thread 98b of the cylindrical section 98 is formed in the inner wall of the large inner diameter hole 104b in a region facing the male thread 98b. A seal member 112 configured from an O ring is arranged on an inside of the seal groove 108, whereby a seal is made between the outer circumferential surface of the cylindrical section 98 and the inner circumferential surface of the large inner diameter hole 104b. Moreover, by the male thread 98b and the female thread 110 being screwed to and engaged with each other, the cylindrical section 98 of the liner 82 and the supplying/discharging-side cap 86 are joined.

The supplying/discharging-side cap 86 has further formed therein a lead-out hole 114 penetrating the supplying/discharging-side cap 86. The lead-out hole 114 is provided in order for the fuel gas interposing between the liner 82 and the reinforced layer 80 (hereafter, also called a covered section 115) to be led out to outside of the covered section 115. Specifically, one of openings, namely, an opening 116, of the lead-out hole 114 is provided in the end surface 102a of the supplying/discharging-side cap 86, and the other of the openings, namely, an opening 118, of the lead-out hole 114 is provided in the tip surface 100a (an exposed surface) of the projection 100. In other words, the fuel gas that has entered the covered section 115 flows into the lead-out hole 114 via the one of the openings, namely, the opening 116, and is discharged from the lead-out hole 114 via the other of the openings, namely, the opening 118. Hereafter, the fuel gas that has thus been led out to outside of the covered section 115 by the lead-out hole 114 will also be called a temporary release fluid. Note that the supplying/discharging-side cap 86 may be provided with only one lead-out hole 114, or may be provided with a plurality of the lead-out holes 114 at fixed intervals in a circumferential direction of the supplying/discharging-side cap 86.

The inserting member 88 includes: a head section 120 of which the outer diameter is larger than a diameter of the medium inner diameter hole 104a; and an inserting section 122 that extends from the head section 120 toward an inside of the insertion hole 104. In the inserting member 88, the inserting section 122 is inserted in the insertion hole 104 along circumferential surfaces of the medium inner diameter hole 104a and small inner diameter hole 104c and an inner circumferential surface of the collar 106. At this time, a supporting plate 124 for attaching the cover member 18 to the high pressure tank 16 is sandwiched between the head section 120 of the inserting member 88 exposed from the insertion hole 104 and the tip surface 100a of the projection 100, as will be mentioned later.

An outer circumferential surface of a portion facing the small inner diameter hole 104c in the insertion hole 104, of the inserting section 122 has formed therein an annular seal groove 126 that follows the circumferential direction, and there is arranged on an inside of the seal groove 126 a seal member 128 configured from an O ring. As a result, a seal is made between an outer circumferential surface of the inserting section 122 and an inner circumferential surface of the insertion hole 104.

Moreover, a supplying/discharging hole 130 is formed on an inside of the inserting member 88 penetrating the inserting member 88. The pipe 36 of the supplying/discharging flow path 12 is connected to the supplying/discharging hole 130 via a connecting section 36b. As a result, the supplying/discharging hole 130 communicates the supplying/discharging flow path 12 and the inside of the liner 82. Moreover, an unillustrated main stop valve (an electromagnetic valve) is incorporated in the inside of the inserting member 88, and a configuration is adopted enabling a communicated state and a blocked state of the supplying/discharging flow path 12 and the inside of the liner 82 to be switched by opening/closing the main stop valve.

The connecting section 36b is configured from a large outer diameter section 132 and a small outer diameter section 134 of which the outer diameter is smaller than that of the large outer diameter section 132, and the connecting section 36b has the pipe 36 inserted in its inside. Moreover, the connecting section 36b, by having part of its small outer diameter section 134 inserted in the supplying/discharging hole 130, is fixed to the head section 120 of the inserting member 88. As will be mentioned later, the cover member 18, a seal member 136, and a separating member 138 interpose between the head section 120 and the large outer diameter section 132.

As shown in FIG. 3, the end-side cap 90 is configured similarly to the supplying/discharging-side cap 86 (refer to FIG. 2). In other words, the end-side cap 90 is sheathed by the cylindrical section 98 of the liner 82 via the insertion hole 104. Moreover, the end-side cap 90 also has formed therein the lead-out hole 114 which is for the hydrogen gas that has entered the covered section 115 to be led out to outside of the covered section 115. The lead-out hole 114 penetrates the end-side cap 90. Hereafter, the lead-out hole 114 provided in the supplying/discharging-side cap 86 will also be called a supplying/discharging-side lead-out hole 114a, and the lead-out hole 114 provided in the end-side cap 90 will also be called an end-side lead-out hole 114b.

The inserting member 89 is inserted in the insertion hole 104 of the end-side cap 90. The inserting member 89 is configured similarly to the inserting member 88, apart from there not being formed therein the supplying/discharging hole 130 and not being incorporated therein the above-described main stop valve, and apart from a length in the axial direction of its inserting section 122 being shorter than in the inserting member 88. The supporting plate 124 for attaching the cover member 19 to the high pressure tank 16 is sandwiched between the head section 120 of the inserting member 89 exposed from the insertion hole 104 and the tip surface 100a of the projection 100, as will be mentioned later.

As shown in FIG. 2, the supporting plate 124, by being sandwiched between the head section 120 and the projection 100 as described above, is attached to each of both end sides in the axial direction of the high pressure tank 16, so as to cover a tip side of the projection 100. Specifically, the supporting plate 124 has formed in substantially its center a plate through-hole 124a of larger diameter than an outer diameter of the inserting section 122 and of smaller diameter than the outer diameter of the head section 120. That is, the inserting section 122 is inserted in the coaxially overlapped plate through-hole 124a and insertion hole 104.

An annular seal groove 142 is formed in a place facing the supporting plate 124 more to an outer side in the radial direction of the projection 100 than the opening 118 on a side discharging the temporary release fluid of the lead-out hole 114 is, of the tip surface 100a of the projection 100. A seal member 144 configured from an O ring is arranged on an inside of this seal groove 142, whereby a seal is made between the projection 100 and the supporting plate 124.

The cover member 18 is configured from the likes of rubber or stainless steel (SUS), for example, and is attached to the supporting plate 124 so as to cover the opening 118 of the supplying/discharging-side lead-out hole 114a and the head section 120 being an exposed section exposed from the insertion hole 104 of the inserting member 88. As a result, the cover member 18 is configured capable of storing on its inside the temporary release fluid led out by the supplying/discharging-side lead-out hole 114a. Moreover, the cover member 18 has formed an insertion hole 18a in which the supplying/discharging-side discharge flow path 24a is inserted. The insertion hole 18a penetrates the cover member 18. The inside of the cover member 18 and the supplying/discharging-side discharge flow path 24a communicate via the insertion hole 18a. Therefore, configuring as described above enables the temporary release fluid stored on the inside of the cover member 18 to flow into the supplying/discharging-side discharge flow path 24a.

Furthermore, the cover member 18 has formed therein a through-hole 18b that exposes the connecting section 36b fixed to the head section 120 of the inserting member 88. A diameter of the through-hole 18b is smaller than the outer diameter of the large outer diameter section 132 of the connecting section 36b and larger than the outer diameter of the small outer diameter section 134 of the connecting section 36b. As described above, the following are sandwiched between the large outer diameter section 132 of the connecting section 36b and the head section 120 of the inserting member 88, namely: an outer circumferential portion of the through-hole 18b of the cover member 18; the seal member 136 configured from an O ring; and the separating member 138.

The separating member 138 has a bottomed cylindrical shape having a bottom section 138a in one end thereof, and the small outer diameter section 134 of the connecting section 36b is inserted in a through-hole formed in the bottom section 138a. Moreover, the leaked fluid storage section 20 is integrally connected to an opening section 138b side of the separating member 138. The seal member 136 interposes between the bottom section 138a of the separating member 138 and the cover member 18, whereby communication between the inside of the cover member 18 and the inside of the leaked fluid storage section 20 are blocked (sealed).

The cover member 19 is configured similarly to the cover member 18 apart from not being provided with the through-hole 18b, and is attached to the supporting plate 124 so as to cover the opening 118 of the end-side lead-out hole 114b and the head section 120 being an exposed section exposed from the insertion hole 104 of the inserting member 89. As a result, the cover member 19 is configured capable of storing on its inside the temporary release fluid led out by the end-side lead-out hole 114b. Moreover, the cover member 19 has formed therein the insertion hole 18a in which the end-side discharge flow path 24b is inserted. The insertion hole 18a penetrates the cover member 19. The inside of the cover member 19 and the end-side discharge flow path 24b communicate via the insertion hole 18a. Therefore, configuring as described above enables the temporary release fluid stored on the inside of the cover member 19 to flow into the end-side discharge flow path 24b.

As shown in FIGS. 1 and 2, the leaked fluid storage section 20 is configured by a wall section that at least surrounds the connecting section 36b connecting the pipe 36 of the supplying/discharging flow path 12 and the supplying/discharging hole 130, and the supplying/discharging flow path 12, for example. As a result, the leaked fluid storage section 20 is configured capable of storing the leaked fluid that has leaked, due to an abnormality occurring in the high pressure tank apparatus 10, from a place such as the connecting section 36b or supplying/discharging flow path that has been designed not to leak the fuel gas therefrom during normal operation of the high pressure tank apparatus 10.

The leakage detecting sensor 22 (refer to FIG. 1) is arranged within the leaked fluid storage section 20, and detects the fuel gas within the leaked fluid storage section 20. It is possible to employ as the leakage detecting sensor 22 a variety of hydrogen sensors capable of detecting presence/absence of a leakage of the fuel gas or a leakage amount (a concentration) of the fuel gas.

As shown in FIG. 1, the supplying/discharging-side discharge flow path 24a communicates with the inside of the cover member 18, and leads to the diluting unit 78 the temporary release fluid that has flowed into the supplying/discharging-side discharge flow path 24a from the inside of the cover member 18. Specifically, the supplying/discharging-side discharge flow path 24a is configured capable of communicating with the mixed exhaust gas discharging flow path 66 of the diluting unit 78 via an opening/closing valve 150.

The end-side discharge flow path 24b communicates with the inside of the cover member 19. The temporary release fluid flows into the end-side discharge flow path 24b from the inside of the cover member 19. As a result, the end-side discharge flow path 24b leads to the diluting unit 78 the temporary release fluid that has been led out by the end-side lead-out hole 114b. For example, the end-side discharge flow path 24b is connected to a side more upstream than the opening/closing valve 150 of the supplying/discharging-side discharge flow path 24a, and is thereby configured capable of communicating with the mixed exhaust gas discharging flow path 66 via the supplying/discharging-side discharge flow path 24a and the opening/closing valve 150.

Therefore, when the opening/closing valve 150 is set to an opened state, the temporary release fluid that has flowed into the supplying/discharging-side discharge flow path 24a and the end-side discharge flow path 24b can be allowed to flow into the mixed exhaust gas discharging flow path 66. On the other hand, when the opening/closing valve 150 is set to a closed state, the temporary release fluid that has flowed into the supplying/discharging-side discharge flow path 24a and the end-side discharge flow path 24b can be stopped from flowing into the mixed exhaust gas discharging flow path 66.

The high pressure tank apparatus 10 according to the present embodiment is basically configured as above. In operation at a normal time of this high pressure tank apparatus 10, for example, as shown in FIGS. 1 and 2, the fuel gas that has been supplied to the supplying/discharging flow path 12 from a hydrogen replenishment source (not illustrated) via the filling port 26, is supplied to the inside of the liner 82 via the pipe 34, the branch path 28, the pipe 36, the supplying/discharging hole 130, and the main stop valve in the opened state. When the liner 82 has been sufficiently filled with the fuel gas by this supplying, supplying of the fuel gas from the hydrogen replenishment source is stopped.

When electricity generation is performed by the fuel cell system 14, the oxygen-containing gas is taken into the oxygen-containing gas supplying flow path 58 under rotational operation of the air pump 62, and the fuel gas in the liner 82 is supplied to the fuel gas supplying flow path 54 via the supplying/discharging flow path 12. Specifically, a switching valve or the like (not illustrated) of the supplying/discharging flow path 12 is operated to discharge the fuel gas to the pipe 36, via the supplying/discharging hole 130 and the main stop valve in the opened state, from the inside of the liner 82. As a result, the fuel gas that has had its pressure adjusted by the regulator 30 is supplied to the fuel gas supplying flow path 54 via the pipe 38.

The oxygen-containing gas that has been supplied to the oxygen-containing gas supplying flow path 58 is supplied to each of the cathode electrodes 48 of the fuel cell 42 via the oxygen-containing gas supply port 42b. Moreover, the fuel gas that has been supplied to the fuel gas supplying flow path 54 is supplied to the each of the anode electrodes 46 of the fuel cell 42 via the injector, the ejector 64, and the fuel gas supply port 42a. As a result, the electricity generating reaction consuming the fuel gas and the oxygen-containing gas occurs, and the fuel cell 42 enters electricity generation operation.

The oxygen-containing gas whose oxygen has been partly consumed in the above-described electricity generating reaction is discharged into the cathode off-gas discharging flow path 60 from the cathode off-gas discharge port 42d as the cathode off-gas, and flows into the mixed exhaust gas discharging flow path 66 via the cathode off-gas discharging flow path 60.

The fuel gas that has been partially consumed in the above-described electricity generating reaction is discharged into the anode off-gas discharging flow path 56 from the anode off-gas discharge port 42c as the anode off-gas, and then flows into the gas-liquid separator 68. As a result, the anode off-gas is separated into the circulating gas being a gas component and the discharge fluid including a liquid.

As described above, a negative pressure occurs in the circulation flow path 70 connected to the ejector 64, due to the fuel gas being injected to the upstream side of the ejector 64 via the injector. As a result, the circulating gas discharged from the gas discharge port 68a is sucked into the ejector 64 via the circulation flow path 70, and in a state of having been mixed with the fuel gas newly supplied to the fuel gas supplying flow path 54, is again supplied to each of the anode electrodes 46 of the fuel cell 42.

The discharge fluid discharged from the liquid discharge port 68b flows into the mixed exhaust gas discharging flow path 66 via the connection flow path 72 when the drain valve 74 is in the opened state. As described above, the discharge fluid is caused to flow into the mixed exhaust gas discharging flow path 66 while the cathode off-gas is flowing into the mixed exhaust gas discharging flow path 66, and this results in the cathode off-gas and the discharge fluid being mixed, thereby enabling the discharge fluid to be diluted. Moreover, the cathode off-gas and the discharge fluid that have been mixed in the mixed exhaust gas discharging flow path 66 are led into the diluter 76 provided downstream of the mixed exhaust gas discharging flow path 66, and are mixed with the atmosphere to be further diluted.

That is, in the diluting unit 78, when the cathode off-gas is being led into the mixed exhaust gas discharging flow path 66, in other words, when the air pump 62 is being driven, dilution operation that dilutes the fluid such as the discharge fluid supplied to the mixed exhaust gas discharging flow path 66 can be performed. Moreover, the diluting unit 78 can perform dilution operation also during the likes of running of the mounting body in which a running wind can be taken into the diluter 76, for example. When the internal pressure of the liner 82 lowers due to the fuel gas being discharged during electricity generation operation of the fuel cell 42 as described above, the pressing force with which the liner 82 is pressed toward the reinforced layer 80 also decreases. Hence, when the internal pressure of the liner 82 falls below a certain magnitude, it becomes easier for the fuel gas that has permeated the liner 82 to enter the covered section 115.

As shown in FIG. 2, the temporary release fluid led out by the supplying/discharging-side lead-out hole 114a, of the fuel gas that has entered the covered section 115 flows into the supplying/discharging-side discharge flow path 24a via the insertion hole 18a from the inside of the cover member 18. Moreover, the temporary release fluid led out by the end-side lead-out hole 114b, of the fuel gas that has entered the covered section 115 flows into the end-side discharge flow path 24b via the insertion hole 18a from the inside of the cover member 19.

On the other hand, regarding the leaked fluid that has leaked from the connecting section 36b or supplying/discharging flow path 12 due to an abnormality occurring in the high pressure tank apparatus 10, as in such cases as when, for example, slackness has occurred in the connecting section 36b or connecting sections of the pipes 34, 36, 38 of the supplying/discharging flow path 12, this leaked fluid is stored in the leaked fluid storage section 20. At this time, the inside of the cover member 18 and the inside of the leaked fluid storage section 20 do not communicate (are blocked) as described above, so the leaked fluid is stored in the leaked fluid storage section 20 without entering the inside of the cover member 18.

In other words, the leaked fluid can be stored in the leaked fluid storage section 20 separately from the temporary release fluid, and the temporary release fluid can be caused to flow into the supplying/discharging-side discharge flow path 24a and the end-side discharge flow path 24b separately from the leaked fluid.

By thus detecting by the leakage detecting sensor 22 the leaked fluid within the leaked fluid storage section 20 that does not include the temporary release fluid, the leaked fluid leaking during an abnormality can be detected distinctly from the temporary release fluid led out during normal operation. As a result, it can be avoided mistakenly detecting during normal operation of the high pressure tank apparatus 10 that a leakage during an abnormality has occurred.

Moreover, in the high pressure tank apparatus 10, the temporary release fluid that has flowed into the supplying/discharging-side discharge flow path 24a and the end-side discharge flow path 24b can be led into the mixed exhaust gas discharging flow path 66 of the diluting unit 78, by opening the opening/closing valve 150. As a result, in the diluting unit 78, the temporary release fluid can be diluted along with the discharge fluid. In other words, the diluting unit 78 additionally provided to the fuel cell system 14 can be utilized to dilute the temporary release fluid.

Hence, when the high pressure tank apparatus 10 is mounted in the mounting body, there is no need for the mounting body to be newly provided with a configuration for diluting the temporary release fluid. Moreover, since there is no concern in the case of the high pressure tank apparatus 10 having been arranged below a floor (not illustrated) of the mounting body being the fuel cell vehicle, that the undiluted temporary release fluid will enter a cabin (not illustrated) via the floor, then there is no need for the mounting body to be newly provided with a configuration for increasing a sealing property of the floor, either. It may be understood from these that the high pressure tank apparatus 10 can be easily mounted in the mounting body at low cost.

Furthermore, by having the temporary release fluid led to the diluting unit 78 by the supplying/discharging-side discharge flow path 24a and the end-side discharge flow path 24b as described above, it is possible to effectively suppress accumulation of the fluid in the covered section 115. As a result, it is possible to suppress that there occurs in the liner 82 a portion that has separated from the reinforced layer 80, or that there occurs so-called buckling where this portion that has separated from the reinforced layer 80 of the liner 82 bulges out toward an inner side of the liner 82, and it is possible to improve durability of the high pressure tank 16.

In the high pressure tank apparatus 10, it is preferable that the opening/closing valve 150 is opened during dilution operation of the diluting unit 78, like during drive of the air pump 62 or during running of the mounting body, and so on. In this case, it becomes possible for the temporary release fluid that has been led to the diluting unit 78 by the supplying/discharging-side discharge flow path 24a and the end-side discharge flow path 24b to be more certainly diluted.

In the high pressure tank apparatus 10, it is particularly preferable that the opening/closing valve 150 is opened during electricity generation operation of the fuel cell 42. During electricity generation operation of the fuel cell 42, the air pump 62 is in drive, and the diluting unit 78 is in dilution operation to dilute the anode off-gas using the cathode off-gas. Moreover, as described above, during electricity generation operation of the fuel cell 42, the fluid is being discharged from the liner 82, so it becomes easier for the temporary release fluid to be led out by the supplying/discharging-side lead-out hole 114a and the end-side lead-out hole 114b.

Hence, by the opening/closing valve 150 being opened during electricity generation operation of the fuel cell 42, the temporary release fluid can be effectively led to the diluting unit 78 and can be certainly diluted by the diluting unit 78, at a timing when it is easy for the temporary release fluid to flow into the supplying/discharging-side discharge flow path 24a and the end-side discharge flow path 24b.

Note that in a case such as when, for example, the mounting body includes a battery (not illustrated) which is chargeable by electricity generation in the fuel cell system 14, and the mounting body is driven by electric power of the battery, the mounting body can be run even while the fuel cell 42 is not performing electricity generation operation. Thus, even while the fuel cell 42 is not performing electricity generation operation, the diluting unit 78 can perform dilution operation when a running wind is led into the diluter 76 due to the mounting body running.

Moreover, even while the fuel cell 42 is not performing electricity generation operation, the unused oxygen-containing gas (air) can be discharged from the cathode off-gas discharge port 42d by driving the air pump 62. In this case, the unused oxygen-containing gas can be caused to flow into the mixed exhaust gas discharging flow path 66 via the cathode off-gas discharging flow path 60, so the diluting unit 78 can perform dilution operation using the unused oxygen-containing gas.

The present invention is not particularly limited to the above-described embodiment, and may be variously modified in a range not departing from the spirit of the present invention.

In the above-described high pressure tank apparatus 10, a configuration was adopted in which the temporary release fluid was caused to flow into the supplying/discharging-side discharge flow path 24a and the end-side discharge flow path 24b via the insides of the cover members 18, 19. However, the present invention is not particularly limited to this, and in the high pressure tank apparatus 10, all that is required is that the leaked fluid storage section 20 which is capable of storing the leaked fluid, and the supplying/discharging-side discharge flow path 24a by which the temporary release fluid is led to the diluting unit 78, are provided independently.

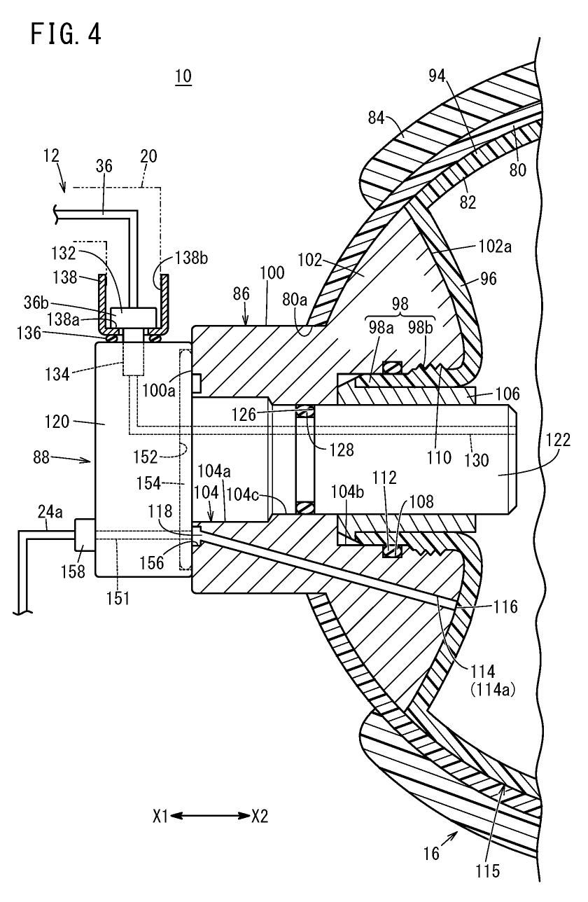

For example, as shown in FIG. 4, the above-described high pressure tank apparatus 10 need not include the cover member 18 and the supporting plate 124 (refer to FIG. 2). In this case, a communicating hole 151 is formed in the head section 120 of the inserting member 88 penetrating the head section 120 of the inserting member 88. Moreover, the head section 120 of the inserting member 88 is provided with a seal groove 152 instead of the seal groove 142 (refer to FIG. 2) formed in the tip surface 100a of the projection 100 of the supplying/discharging-side cap 86.

The seal groove 152 is formed in a surface facing the tip surface 100a more to an outer side in the radial direction of the projection 100 than the opening 118 of the supplying/discharging-side lead-out hole 114a is, of the head section 120. A seal member 154 configured from an O ring is arranged on an inside of this seal groove 152, whereby a seal is made between the head section 120 of the inserting member 88 and a side more outward in the radial direction than the opening 118 is, of the tip surface 100a of the projection 100.

Note that when the supplying/discharging-side cap 86 is provided with a plurality of the supplying/discharging-side lead-out holes 114a, there may be provided in the tip surface 100a an annular communicating groove 156 that communicates in the radial direction each of the openings 118 of the plurality of supplying/discharging-side lead-out holes 114a. One end side of the communicating hole 151 opens toward the communicating groove 156. The supplying/discharging-side discharge flow path 24a is connected to the other end side of the communicating hole 151 via a connecting section 158. Therefore, each of the plurality of supplying/discharging-side lead-out holes 114a communicates with the supplying/discharging-side discharge flow path 24a via the communicating groove 156 and the communicating hole 151.

The seal member 136 and the separating member 138 are sandwiched between the large outer diameter section 132 of the connecting section 36b and the head section 120. That is, the leaked fluid storage section 20 is provided to the high pressure tank 16 independently from the supplying/discharging-side discharge flow path 24a. Therefore, in this case too, the leaked fluid can be stored in the leaked fluid storage section 20 separately from the temporary release fluid, and the temporary release fluid can be caused to flow into the supplying/discharging-side discharge flow path 24a separately from the leaked fluid.

Although the above-described high pressure tank apparatus 10 adopted a configuration in which the high pressure tank 16 included the end-side cap 90 where the end-side lead-out hole 114b was formed, and the end-side discharge flow path 24b was connected to the end-side lead-out hole 114b, the present invention is not particularly limited to these. For example, the high pressure tank 16 need not include the end-side cap 90. Moreover, the end-side cap 90 need not be provided with the end-side lead-out hole 114b. In these cases, the high pressure tank apparatus 10 need not include the end-side discharge flow path 24b.

Furthermore, in the high pressure tank apparatus 10, an end-side cap 90 side of the high pressure tank 16 may be configured without including the cover member 19 and the supporting plate 124, substantially similarly to the modified example shown in FIG. 4. In this case, the temporary release fluid led out from the end-side lead-out hole 114b flows into the end-side discharge flow path 24b via the communicating groove 156 provided in the end-side cap 90 and the communicating hole 151 provided in the inserting member 89 similarly to the supplying/discharging-side cap 86 shown in FIG. 4.

The above-described high pressure tank apparatus 10 adopted a configuration where, due to the leaked fluid storage section 20 surrounding both the connecting section 36b and the supplying/discharging flow path 12, both the leaked fluid that had leaked from the connecting section 36b and the leaked fluid that had leaked from the supplying/discharging flow path 12 could be stored. However, the leaked fluid storage section 20 may be configured capable of storing at least the leaked fluid leaking from the connecting section 36b.

Although the above-described high pressure tank apparatus 10 adopted a configuration of including one high pressure tank 16, it may include a plurality of the high pressure tanks 16. In this case, the leaked fluid leaking from the plurality of high pressure tanks 16 may be stored by one leaked fluid storage section 20, or there may be provided a plurality of the leaked fluid storage sections 20 of the same number as there are high pressure tanks 16, and the leaked fluid may be stored in the leaked fluid storage section 20 for each of the high pressure tanks 16.

The supplying/discharging flow path 12 is not limited to being configured from the likes of the above-described pipes 34, 36, 38, or branch path 28, and there may be adopted a variety of configurations enabling the fuel gas (the fluid) to be supplied/discharged to/from the high pressure tank 16.

What is claimed is:

1. A high pressure tank apparatus that comprises a high pressure tank in which a fluid is supplied/discharged to/from a resin-made liner via a supplying/discharging flow path and which enables the fluid that has been stored in the liner to be supplied to an anode electrode of a fuel cell,
the high pressure tank including:
a reinforced layer covering an outer surface of the liner;
an inserting member having formed therein a supplying/discharging hole that is connected to the supplying/discharging flow path via a connecting section and that is capable of communicating the supplying/discharging flow path and an inside of the liner; and
a cap having formed therein each of a lead-out hole that leads out the fluid interposing between the liner and the reinforced layer and an insertion hole in which the inserting member is inserted,
the high pressure tank apparatus comprising:
a leaked fluid storage section capable of storing a leaked fluid being the fluid that has leaked from at least the connecting section; and
a discharge flow path that is provided independently from the leaked fluid storage section and by which a temporary release fluid being the fluid that has been led out via the lead-out hole is led to a diluting unit that dilutes an anode off-gas that has been discharged from the anode electrode.

2. The high pressure tank apparatus according to claim 1, further comprising
an opening/closing valve that opens/closes the discharge flow path,
wherein the opening/closing valve is opened during dilution operation by the diluting unit.

3. The high pressure tank apparatus according to claim 2, wherein
the opening/closing valve is opened during electricity generation operation of the fuel cell.
